(19) United States
(12) Patent Application Publication
(10) Pub. No.: US 2026/0036820 A1
(43) Pub. Date: Feb. 5, 2026

(54) BEAM SPLITTER AND OPTICAL WAVELENGTH SELECTIVE SWITCH SYSTEM

(71) Applicant: FUJIFILM Corporation, Tokyo (JP)

(72) Inventors: Kazuya HISANAGA, Minamiashigara-shi (JP); Yujiro YANAI, Minamiashigara-shi (JP); Yukito SAITOH, Minamiashigara-shi (JP)

(73) Assignee: FUJIFILM Corporation, Tokyo (JP)

(21) Appl. No.: 19/355,458

(22) Filed: Oct. 10, 2025

Related U.S. Application Data
(63) Continuation of application No. PCT/JP2024/014797, filed on Apr. 12, 2024.

(30) Foreign Application Priority Data
Apr. 13, 2023 (JP) 2023-065750

(51) Int. Cl. G02B 27/10; G02B 1/06; G02B 5/30; G02B 27/30

(52) U.S. Cl. CPC G02B 27/1086; G02B 5/3083; G02B 27/30; G02B 1/06

(57) ABSTRACT

Provided are a thin beam splitter and an optical wavelength selective switch system including the beam splitter. The beam splitter includes: a light splitting element that splits incident light in two directions; and a light collimating member for collimating the split light components, in which the light splitting element is a diffractive element, and a splitting angle of the light splitting element is 20° or more.

### CROSS-REFERENCE TO RELATED APPLICATIONS

This application is a Continuation of PCT International Application No. PCT/JP2024/014797 filed on Apr. 12, 2024, which claims priority under 35 U.S.C. § 119 (a) to Japanese Patent Application No. 2023-065750 filed on Apr. 13, 2023. The above applications are hereby expressly incorporated by reference, in their entirety, into the present application.

### BACKGROUND OF THE INVENTION

### 1. Field of the Invention

The present invention relates to a field of an optical communication technique, and particularly relates to a beam splitter and an optical wavelength selective switch system.

### 2. Description of the Related Art

In order to deal with an increase in network capacity in an optical transmission network, it is desired to increase the performance of an optical wavelength selective switch (WSS) used in wavelength division multiplexing and to increase the number of usable switches through a reduction in size.

In the current optical wavelength selective switch system, a beam splitter is used for splitting and adjusting an input beam or an output beam (for example, JP2016-103021A). Typically, the following method is used. Regarding the input beam, the beam spread is adjusted by a micro lens array, a collimating lens, or the like, and the adjusted input beam is incident into the beam splitter. As the beam splitter, for example, a beam displacer or a Wollaston prism is used. After passing through this element, the input beam is split into two beams. Polarization states of these beams are linearly polarized light components whose polarization directions are perpendicular to each other. The polarization state of one beam is rotated by a retardation plate to obtain linearly polarized light components whose polarization directions are parallel to each other. In addition, by allowing the two beams to be incident into a desired location of the element, the same optical path can also be obtained. A material of this beam splitter consists of MgF₂, YVO₄, calcite, or the like.

However, regarding this beam splitter, the element thickness increases due to characteristics of the material. In addition, the position adjustment of the element is necessary for appropriately splitting and adjusting light in a desired direction, and a space for the position adjustment is further necessary in the vicinity of the element, which is a rate-controlling factor for a reduction in the size of the entire device. In addition, surface smoothness is very important. Therefore, a high-precision polishing technique is necessary, and a complicated process is also necessary for assembly of the element.

### SUMMARY OF THE INVENTION

An object of the present invention is to provide a thin beam splitter and an optical wavelength selective switch system including the beam splitter.

In order to achieve the object, the present invention has the following configurations.
[1] A beam splitter comprising:
a light splitting element that splits incident light in two directions; and
a light collimating member for collimating the split light components,
in which the light splitting element is a diffractive element, and
a splitting angle of the light splitting element is 20° or more.
[2] The beam splitter according to [1], in which the light splitting element is a liquid crystal diffractive element.
[3] The beam splitter according to [1] or [2], in which the liquid crystal diffractive element has a twisted structure of liquid crystals.
[4] The beam splitter according to [1] or [2], in which the liquid crystal diffractive element has cholesteric alignment.
[5] The beam splitter according to any one of [1] to [4], further comprising:
a retardation plate that is provided between the light splitting element and the light collimating member or on an emission side of the light collimating member.
[6] An optical wavelength selective switch system comprising:
the beam splitter according to any one of [1] to [5].

According to the present invention, the element itself can be made thin, and the size of the entire device can also be reduced. In addition, the present invention can also provide an optical system.

### BRIEF DESCRIPTION OF THE DRAWINGS

FIG. 1 is a diagram conceptually showing a configuration of the present invention.

FIG. 2 is a diagram showing a configuration example of using a transmissive light splitting element.

FIG. 3 is a diagram showing the configuration example of using the transmissive light splitting element.

FIG. 4 is a diagram showing the configuration example of using the transmissive light splitting element.

FIG. 5 is a diagram showing the configuration example of using the transmissive light splitting element.

FIG. 6 is a diagram showing a configuration example of using a reflective light splitting element.

FIG. 7 is a diagram showing the configuration example of using the reflective light splitting element.

FIG. 8 is a diagram showing the configuration example of using the reflective light splitting element.

### DESCRIPTION OF THE PREFERRED EMBODIMENTS

Hereinafter, the present invention will be specifically described.

The following configuration requirements will be described based on typical embodiments of the present invention in some cases, but the present invention is not limited to the embodiments.

In the present specification, numerical ranges represented by “to” refer to ranges including numerical values before and after “to” as lower limit values and upper limit values.

In the present specification, materials that correspond to each of components may be used alone or in combination of two or more kinds. Here, in a case where two or more kinds of materials are used in combination for each of components, the content of the component refers to the total content of the materials to be combined unless specified otherwise.

In the present specification, “(meth) acrylate” represents “either or both of acrylate and methacrylate”.

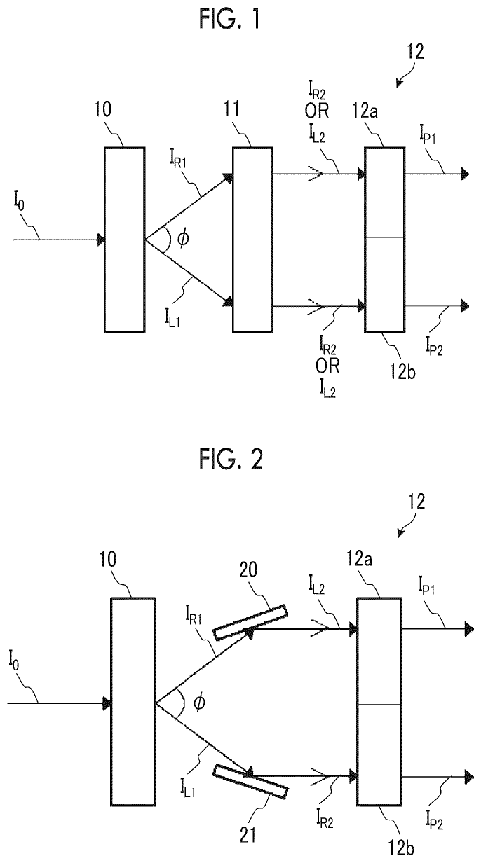

FIG. 1 is a diagram conceptually showing a configuration of a beam splitter according to the embodiment of the present invention.

The beam splitter shown in FIG. 1 includes a light splitting element 10, a light collimating member 11, and a retardation plate 12.

In the beam splitter according to the embodiment of the present invention, the light splitting element 10 splits and emits incident light in different two directions, for example, according to a polarization direction. In addition, in the present invention, the light splitting element 10 is a diffractive element. In addition, a splitting angle of light by the light splitting element 10 is 20° or more.

In the example shown in FIG. 1, the light splitting element 10 allows transmission of incidence light I₀ and splits the incidence light I₀ into dextrorotatory circularly polarized light I_{R1} and levorotatory circularly polarized light I_{L1}.

An angle between the dextrorotatory circularly polarized light I_{R1} and the levorotatory circularly polarized light I_{L1} is φ, and each of the dextrorotatory circularly polarized light I_{R1} and the levorotatory circularly polarized light I_{L1} is emitted at an angle of φ/2 with respect to the normal direction of the light splitting element 10. That is, in FIG. 1, the light splitting element 10 is a polarization splitting element that splits by diffraction circularly polarized light components orthogonal to each other in different directions. In addition, the light splitting element 10 diffracts the dextrorotatory circularly polarized light I_{R1} and the levorotatory circularly polarized light I_{L1} at substantially the same polar angle in orientation directions that are different by 180°. φ/2 that is the angle between the dextrorotatory circularly polarized light I_{R1} or the levorotatory circularly polarized light I_{L1} and the normal direction of the light splitting element 10 includes an error of about ±0.1°. As described above, in the present invention, φ is 20° or more.

In the example shown in FIG. 1, in the light splitting element 10, the incidence light I₀ incident from a direction perpendicular to the surface of the light splitting element 10 is split into the dextrorotatory circularly polarized light I_{R1} and the levorotatory circularly polarized light I_{L1}, the dextrorotatory circularly polarized light I_{R1} is diffracted to travel in the upper right direction in the drawing, and the levorotatory circularly polarized light I_{L1} is diffracted to travel in the lower right direction in the drawing.

The dextrorotatory circularly polarized light I_{R1} and the levorotatory circularly polarized light I_{L1} are incident into the light collimating member 11.

In the beam splitter according to the embodiment of the present invention, the light collimating member 11 is a member that changes travel directions of the light components that are split by the light splitting element 10 to travel in the two different directions such that the light components travel in directions parallel to each other while being split.

In the example shown in FIG. 1, the light collimating member 11 deflects the dextrorotatory circularly polarized light I_{R1} incident from the lower left direction in the drawing such that the dextrorotatory circularly polarized light I_{R1} travels in the right direction in the drawing, and deflects the levorotatory circularly polarized light I_{L1} incident from the upper left direction in the drawing such that the levorotatory circularly polarized light I_{L1} travels in the right direction in the drawing. As a result, dextrorotatory circularly polarized light I_{R2} and levorotatory circularly polarized light I_{L2} travel in directions parallel to each other.

The dextrorotatory circularly polarized light I_{R2} and the levorotatory circularly polarized light I_{L2} that are collimated are incident into the retardation plate 12.

As shown in FIG. 1, the light collimating member 11 may deflect the incident circularly polarized light while maintaining the polarization state of the circularly polarized light, or may convert and deflect the incident circularly polarized light into polarized light components orthogonal to each other.

That is, the light collimating member 11 may deflect the incident dextrorotatory circularly polarized light I_{R1} as the dextrorotatory circularly polarized light I_{R2} without any change, and may deflect the incident levorotatory circularly polarized light I_{L1} as the levorotatory circularly polarized light I_{L2} without any change. Alternatively, the light collimating member 11 may convert the incident dextrorotatory circularly polarized light I_{R1} into the levorotatory circularly polarized light I_{L2} to deflect the levorotatory circularly polarized light I_{L2}, and may convert the incident levorotatory circularly polarized light I_{L1} into the dextrorotatory circularly polarized light I_{R2} to deflect the dextrorotatory circularly polarized light I_{R2}.

In the example shown in FIG. 1, as a preferable aspect, the retardation plate 12 is provided. The retardation plate 12 is a member that changes the polarization state of light split by the light splitting element 10.

In the example shown in FIG. 1, the retardation plate 12 is disposed on an emission side of the light collimating member 11, converts the incident dextrorotatory circularly polarized light I_{R2} into linearly polarized light (P polarized light I_{P1}), and converts the incident levorotatory circularly polarized light I_{L2} into linearly polarized light (P polarized light I_{P2}). That is, in the example shown in FIG. 1, the retardation plate 12 converts the dextrorotatory circularly polarized light I_{R2} and the levorotatory circularly polarized light I_{L2} into linearly polarized light components having the same polarization direction. The linearly polarized light emitted from the retardation plate 12 being P polarized light represents linearly polarized light in a polarization state that is incident as P polarized light with respect to an optical member disposed on a rear stage of the retardation plate 12.

Accordingly, the retardation plate 12 is a λ/4 plate, and slow axis directions of a region 12a where the dextrorotatory circularly polarized light I_{R1} is incident and a region 12b where the levorotatory circularly polarized light I_{L1} is incident are different by substantially 90°.

From the above, the beam splitter shown in FIG. 1 splits incident light into two linearly polarized light components to emit the two linearly polarized light components in directions parallel to each other.

In the beam splitter according to the embodiment of the present invention, a diffractive element is used as the light splitting element. Therefore, even in a case where a splitting angle of light by the light splitting element is 20° or more, the light splitting element can be thinned. In addition, the splitting angle of light by the light splitting element is 20° or more, and thus even in a case where a distance between the light splitting element and the light collimating member is short, travel directions of the split light components can be collimated in a state where the split light components are sufficiently spaced. Therefore, the thickness (size) of the entire device can be reduced.

In the example shown in FIG. 1, the retardation plate 12 is disposed on the emission side of the light collimating member 11. However, the present invention is not limited to this example, and the retardation plate 12 may be disposed between the light splitting element 10 and the light collimating member 11. Regarding this point, the same also applies to each example described below.

In addition, in the example shown in FIG. 1, the retardation plate 12 converts the dextrorotatory circularly polarized light I_{R2} and the levorotatory circularly polarized light I_{L2} that are incident into linearly polarized light components having the same orientation. However, the present invention is not limited to this example, and the dextrorotatory circularly polarized light I_{R2} and the levorotatory circularly polarized light I_{L2} may be converted into linearly polarized light components orthogonal to each other. In this case, the retardation plate 12 is a λ/4 plate, and slow axis directions of the region 12a where the dextrorotatory circularly polarized light I_{R1} is incident and the region 12b where the levorotatory circularly polarized light I_{L1} is incident are aligned. Regarding this point, the same also applies to each example described below.

In addition, in the example shown in FIG. 1, the configuration including the retardation plate 12 is adopted. However, a configuration not including the retardation plate may be adopted. In this case, the beam splitter can emit the split circularly polarized light components in directions parallel to each other. Regarding this point, the same also applies to each example described below.

### [Light Splitting Element]

The light splitting element 10 shown in FIG. 1 is a transmissive diffractive element represented by a liquid crystal diffractive element including a support, a photo-alignment film, and an optically anisotropic film, a surface relief element having a fine uneven pattern, or the like. The liquid crystal diffractive element splits incident light into dextrorotatory circularly polarized light and levorotatory circularly polarized light. In addition, the surface relief element splits incident light into linearly polarized light components orthogonal to each other. In particular, the optically anisotropic film may be a film that is formed of a composition including a liquid crystal compound and has a predetermined liquid crystal alignment pattern in which an orientation of an optical axis derived from the liquid crystal compound continuously rotates in one in-plane direction. In addition, it is preferable that the optically anisotropic film has a so-called twisted structure in which the orientation of the optical axis of the liquid crystal compound continuously changes from one interface side to the other interface side in a thickness direction from the viewpoint of increasing the efficiency of diffracted light and obtaining polarization preservation, and the like.

On the other hand, the light splitting element 10 shown in FIG. 6 below is a reflective diffractive element represented by a liquid crystal diffractive element including a support, a photo-alignment film, and an optically anisotropic film, a surface relief element having a fine uneven pattern, or the like. In particular, the optically anisotropic film is formed of a composition including a liquid crystal compound and has a predetermined liquid crystal alignment pattern in which an orientation of an optical axis derived from the liquid crystal compound continuously rotates in one in-plane direction. In addition, in the thickness direction, the reflective diffractive element has the twisted structure as described above, and is characterized in that, as compared to the transmissive diffractive element, a period (so-called pitch period) of the twisted structure is short and it has cholesteric alignment.

In the transmissive liquid crystal diffractive element, the twist of the twisted structure in the thickness direction is less than one turn, that is, a twisted angle thereof is less than 360° The twisted angle of the liquid crystal compound in the thickness direction is preferably about 10° to 200° and more preferably 20° to 180°. On the other hand, in the cholesteric alignment, the twisted angle is 360° or more, and selective reflectivity in which specific circularly polarized light in a specific wavelength range is reflected is exhibited. In the present specification, “twisted alignment” does not include cholesteric alignment, and selective reflectivity does not occur in the liquid crystal diffractive element (optically anisotropic film) having the twisted alignment.

The liquid crystal diffractive element, the support, the photo-alignment film, and the optically anisotropic film can be found in WO2021/256413A. Note that, in a case where, for use in optical communication, the fact that the used wavelength is infrared needs to be considered. Since the optically anisotropic film functions as the liquid crystal diffractive element, the support and/or the photo-alignment film does not need to be provided.

### (Transmissive Liquid Crystal Diffractive Element)

As is well known, the transmissive liquid crystal diffractive element diffracts incident circularly polarized light according to the turning direction. Therefore, by diffracting a dextrorotatory circularly polarized light component and a levorotatory circularly polarized light component of incident light in different directions, the light can be split.

In addition, a diffraction angle in the transmissive liquid crystal diffractive element is determined depending on a distance (in-plane pitch a) in which the orientation of the liquid crystal compound continuously changes from 0 to 180° in a plane in the predetermined liquid crystal alignment pattern in which the orientation of the optical axis derived from the liquid crystal compound rotates in the one in-plane direction.

In the case of the transmissive liquid crystal diffractive element, a liquid crystal material and a film thickness may be appropriately selected such that Δnλ×d represented by the product of refractive index anisotropy Δnλ at a wavelength λ [nm] of the optically anisotropic film and a film thickness d [nm] of the liquid crystal layer is λ/2.

In addition, the in-plane pitch a [nm] is determined from the following expression of first-order diffracted light, and the photo-alignment film may also be appropriately subjected to interference exposure based on the in-plane pitch a.

$$n \times a \times ( sin β - sin α ) = λ$$

Here, the in-plane pitch a is a distance in which liquid crystal molecules continuously change from 0 to 180° in a plane. In addition, n represents an environmental refractive index of the incidence side in contact with the liquid crystal diffractive element, a represents an angle between light incident into the liquid crystal diffractive element and the normal line of the liquid crystal diffractive element surface, and β represents an angle between transmitted diffracted light and the normal line of the liquid crystal diffractive element surface, and λ represents a wavelength [nm] of incidence light.

### (Reflective Liquid Crystal Diffractive Element)

As is well known, the reflective liquid crystal diffractive element (cholesteric liquid crystal layer) has not only wavelength selectivity but also circular polarization selectivity. Therefore, in incident light, one circularly polarized light is reflected, and transmission of the other circularly polarized light is allowed. In the present application, the reflective liquid crystal diffractive element includes a cholesteric liquid crystal layer that reflects and diffracts dextrorotatory circularly polarized light and a cholesteric liquid crystal layer that reflects and diffracts levorotatory circularly polarized light. By allowing the diffraction direction of the dextrorotatory circularly polarized light and the diffraction direction of the levorotatory circularly polarized light to be different from each other, the reflective liquid crystal diffractive element can split light.

The circular polarization selectivity in the cholesteric liquid crystal layer is determined depending on the rotation direction of the orientation of the liquid crystal compound in the thickness direction of the cholesteric liquid crystal layer.

In addition, a diffraction angle in the cholesteric liquid crystal layer as the reflective liquid crystal diffractive element is determined depending on a distance (in-plane pitch a) in which the orientation of the liquid crystal compound continuously changes from 0 to 180° in a plane in the predetermined liquid crystal alignment pattern in which the orientation of the optical axis derived from the liquid crystal compound rotates in the one in-plane direction.

In addition, in the case of the reflective diffractive element, the in-plane pitch a [nm] is determined from the following expression of first-order diffracted light, and the photo-alignment film may also be appropriately subjected to interference exposure based on the in-plane pitch a.

$$n \times a \times ( sin β - sin α ) = λ$$

Here, n represents an environmental refractive index of the incidence side in contact with the liquid crystal diffractive element, α represents an angle between light incident into the liquid crystal diffractive element and the normal line of the liquid crystal diffractive element surface, and β represents an angle between reflected diffracted light of the liquid crystal diffractive element and the normal line of the liquid crystal diffractive element surface, and λ represents a wavelength [nm] of incidence light.

Here, the optically anisotropic film needs to have cholesteric alignment in the thickness direction, and the film thickness d [nm] of the liquid crystal layer may be appropriately adjusted depending on the required efficiency.

For example, in order to improve the light utilization efficiency, the thickness of liquid crystals may be adjusted to 7 times or more of the pitch of the cholesteric alignment (thickness where the orientation of the liquid crystal molecules changes from 0° to 360° in the thickness direction). In addition, the pitch may be appropriately determined depending on the wavelength to be used.

(Formation of in-Plane Alignment Pattern)

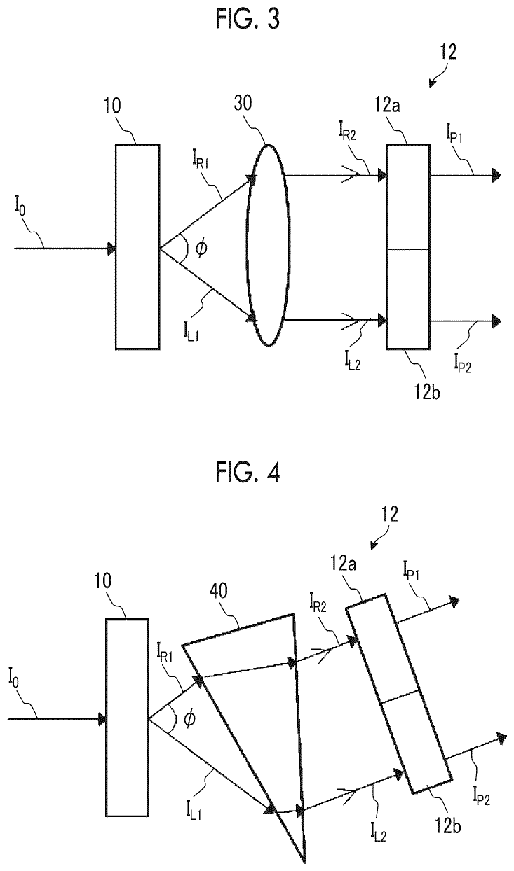

In addition, in order to form the in-plane alignment pattern required for diffraction, although not particularly limited thereto, interference exposure using circularly polarized light may be used as in an exposure device shown in FIG. 3 of WO2021/256413A. In order to obtain the in-plane pitch required for the splitting angle, an optical element of the exposure device may be provided such that absolute values of incidence angles of the interference exposure with respect to the normal direction of the photo-alignment film surface are the same.

### (Formation of Twisted Structure or Cholesteric Alignment)

In order to obtain the twisted structure or the cholesteric alignment in the thickness direction, the addition amount of a chiral agent may be appropriately adjusted as described in WO2021/256413A.

### [Light Collimating Member]

In FIG. 1, the dextrorotatory circularly polarized light I_{R1} and the levorotatory circularly polarized light I_{L1} emitted from the light splitting element 10 are incident into the light collimating member 11 to be converted into parallel light.

In this case, the parallel light only needs to be parallel light that can be applied as a wavelength selective switch instead of strictly parallel light, and the error thereof is about ±0.1°.

The light collimating member for collimating the split light components may be a refractive element, a diffractive element, or a reflective element, but is not limited thereto. For example, the refractive element is a lens, a prism, or the like, and the reflective element is a mirror. In addition, the diffractive element is not particularly limited, and the liquid crystal diffractive element is preferable from the viewpoint that the size of the entire device can be reduced because the element itself is thin and is bondable.

### [Retardation Plate]

The retardation plate is not particularly limited, but is preferable because a change in polarization such as reflection or refraction is not likely to occur in a state where the polarization state after the passage is linearly polarized light. In addition, the material is not particularly limited, and a well-known material such as a polymer, liquid crystal, or an inorganic matter can be used.

FIG. 2 is a diagram conceptually showing another example of the configuration of the beam splitter according to the embodiment of the present invention.

The beam splitter shown in FIG. 2 includes the light splitting element 10, two mirrors 20 and 21 as the light collimating member, and the retardation plate 12. The example shown in FIG. 2 has the same configuration as the example shown in FIG. 1, except that it includes the two mirrors 20 and 21 as the light collimating member, and thus different points will be mainly described in the following description.

In FIG. 2, the mirror 20 is disposed on an optical path of the dextrorotatory circularly polarized light I_{R1} split by the light splitting element 10, and reflects the incident dextrorotatory circularly polarized light I_{R1} to change the travel direction. In the example shown in FIG. 2, the mirror 20 reflects the dextrorotatory circularly polarized light I_{R1} traveling in the upper right direction in the drawing such that the dextrorotatory circularly polarized light I_{R1} travels in the right direction in the drawing. The circularly polarized light reflected from the mirror 20 is converted in polarization direction, and thus is emitted as the levorotatory circularly polarized light I_{L2}.

In addition, the mirror 21 is disposed on an optical path of the levorotatory circularly polarized light In split by the light splitting element 10, and reflects the incident levorotatory circularly polarized light IL to change the travel direction. In the example shown in FIG. 2, the mirror 21 reflects the levorotatory circularly polarized light IL traveling in the lower right direction in the drawing such that the levorotatory circularly polarized light IL travels in the right direction in the drawing. The circularly polarized light reflected from the mirror 21 is emitted as the dextrorotatory circularly polarized light I_{R2}.

The levorotatory circularly polarized light I_{L2} reflected from the mirror 20 is incident into the region 12a of the retardation plate 12 to be converted into the linearly polarized light I_{P1}, and the dextrorotatory circularly polarized light I_{R2} reflected from the mirror 21 is incident into the region 12b of the retardation plate 12 to be converted into the linearly polarized light I_{P2}.

From the above, the beam splitter shown in FIG. 2 splits incident light into two linearly polarized light components to emit the two linearly polarized light components in directions parallel to each other.

FIG. 3 is a diagram conceptually showing another example of the configuration of the beam splitter according to the embodiment of the present invention.

The beam splitter shown in FIG. 3 includes the light splitting element 10, a lens 30 as the light collimating member, and the retardation plate 12. The example shown in FIG. 3 has the same configuration as the example shown in FIG. 1, except that it includes the lens 30 as the light collimating member, and thus different points will be mainly described in the following description.

In FIG. 3, the lens 30 is a convex lens (condenser lens), and changes the respective travel directions of the dextrorotatory circularly polarized light I_{R1} and the levorotatory circularly polarized light I_{L1} split by the light splitting element 10 to directions parallel to each other due to the focusing action.

Specifically, as shown in FIG. 3, the dextrorotatory circularly polarized light I_{R1} split by the light splitting element 10 travels in the upper right direction in the drawing to be incident into the vicinity of an end part of the lens 30 on the upper side in the drawing. Due to the focusing action of the lens 30, the travel direction of the dextrorotatory circularly polarized light I_{R1} incident into the lens 30 is bent to the central axis side such that the dextrorotatory circularly polarized light I_{R1} is emitted in the right direction in the drawing. In this case, the dextrorotatory circularly polarized light I_{R1} incident into the lens 30 is emitted as the dextrorotatory circularly polarized light I_{R2} without any change.

In addition, the levorotatory circularly polarized light IL split by the light splitting element 10 travels in the lower right direction in the drawing to be incident into the vicinity of an end part of the lens 30 on the lower side in the drawing. Due to the focusing action of the lens 30, the travel direction of the levorotatory circularly polarized light I_{L1} incident into the lens 30 is bent to the central axis side such that the levorotatory circularly polarized light I_{L1} is emitted in the right direction in the drawing. The levorotatory circularly polarized light I_{L1} incident into the lens 30 is emitted as the levorotatory circularly polarized light I_{L2} without any change.

The dextrorotatory circularly polarized light I_{R2} emitted from the lens 30 is incident into the region 12a of the retardation plate 12 to be converted into the linearly polarized light I_{P1}, and the levorotatory circularly polarized light I_{L2} emitted from the lens 30 is incident into the region 12b of the retardation plate 12 to be converted into the linearly polarized light I_{P2}.

From the above, the beam splitter shown in FIG. 3 splits incident light into two linearly polarized light components to emit the two linearly polarized light components in directions parallel to each other.

FIG. 4 is a diagram conceptually showing another example of the configuration of the beam splitter according to the embodiment of the present invention.

The beam splitter shown in FIG. 4 includes the light splitting element 10, a prism 40 as the light collimating member, and the retardation plate 12. The example shown in FIG. 4 has the same configuration as the example shown in FIG. 1, except that it includes the prism 40 as the light collimating member, and thus different points will be mainly described in the following description.

In FIG. 4, the prism 40 is a so-called triangular prism, and bends and changes the respective travel directions of the dextrorotatory circularly polarized light I_{R1} and the levorotatory circularly polarized light I_{L1} split by the light splitting element 10 to directions parallel to each other.

Specifically, as shown in FIG. 4, a surface (hereinafter, referred to as an incident surface) of the prism 40 into which the dextrorotatory circularly polarized light I_{R1} and the levorotatory circularly polarized light I_{L1} are incident is disposed to be inclined with respect to the surface of the light splitting element 10, and is disposed such that the dextrorotatory circularly polarized light I_{R1} is incident at an angle substantially perpendicular to the incident surface and the levorotatory circularly polarized light I_{L1} is incident from an oblique direction with respect to the incident surface. That is, assuming that the angle of light with respect to the perpendicular of the incident surface is an incidence angle, the prism 40 is disposed such that the incidence angle of the dextrorotatory circularly polarized light I_{R1} is small and the incidence angle of the levorotatory circularly polarized light I_{L1} is large.

The dextrorotatory circularly polarized light I_{R1} incident into the prism 40 at the small incidence angle is emitted in the upper right direction in the drawing without a large change in the travel direction thereof. In addition, in this case, the dextrorotatory circularly polarized light I_{R1} incident into the prism 40 is emitted as the dextrorotatory circularly polarized light I_{R2} without any change.

On the other hand, the levorotatory circularly polarized light I_{L1} incident into the prism 40 at the large incidence angle largely changes in travel direction to be emitted in the upper right direction in the drawing. In addition, in this case, the levorotatory circularly polarized light I_{L1} incident into the prism 40 is emitted as the levorotatory circularly polarized light I_{L2} without any change.

The dextrorotatory circularly polarized light I_{R2} emitted from the prism 40 is incident into the region 12a of the retardation plate 12 to be converted into the linearly polarized light I_{P1}, and the levorotatory circularly polarized light I_{L2} emitted from the prism 40 is incident into the region 12b of the retardation plate 12 to be converted into the linearly polarized light I_{P2}. As shown in FIG. 4, the retardation plate 12 is disposed to align the travel directions of the dextrorotatory circularly polarized light I_{R2} and the levorotatory circularly polarized light I_{L2} emitted from the prism 40 such that the dextrorotatory circularly polarized light I_{R2} and the levorotatory circularly polarized light I_{L2} are substantially vertically incident.

From the above, the beam splitter shown in FIG. 4 splits incident light into two linearly polarized light components to emit the two linearly polarized light components in directions parallel to each other.

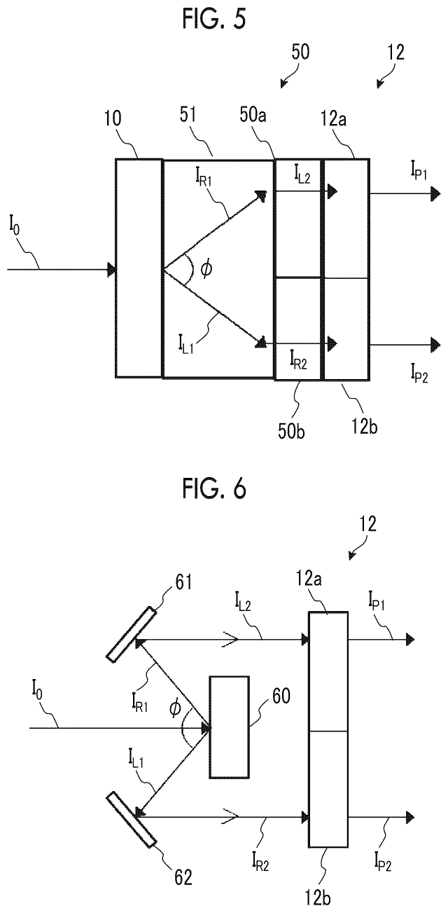

FIG. 5 is a diagram conceptually showing another example of the configuration of the beam splitter according to the embodiment of the present invention.

The beam splitter shown in FIG. 5 includes the light splitting element 10, a support 51, a transmissive liquid crystal diffractive element 50 as the light collimating member, and the retardation plate 12. The example shown in FIG. 5 has the same configuration as the example shown in FIG. 1, except that it includes the transmissive liquid crystal diffractive element 50 as the light collimating member and the support 51, and thus different points will be mainly described in the following description.

In FIG. 5, the light splitting element 10 is disposed on a surface of the support 51 on a side into which light I₀ is incident, and the transmissive liquid crystal diffractive element 50 is disposed on the other surface side of the support 51. That is, the support 51 supports the light splitting element 10 and the transmissive liquid crystal diffractive element 50, and holds a predetermined positional relationship between the light splitting element 10 and the transmissive liquid crystal diffractive element 50. The support 51 is formed of a material such as glass or a resin having a high light-transmitting property with respect to target light.

The dextrorotatory circularly polarized light I_{R1} and the levorotatory circularly polarized light I_{L1} split by the light splitting element 10 pass through the inside of the support 51 to be incident into the transmissive liquid crystal diffractive element 50.

The transmissive liquid crystal diffractive element 50 diffracts incident circularly polarized light according to the turning direction. As in the transmissive liquid crystal diffractive element as the light splitting element 10, the transmissive liquid crystal diffractive element 50 may include an optically anisotropic film, and the optically anisotropic film is formed of a composition including a liquid crystal compound and has a predetermined liquid crystal alignment pattern in which an orientation of an optical axis derived from the liquid crystal compound continuously rotates in one in-plane direction. In addition, it is preferable that the optically anisotropic film in the transmissive liquid crystal diffractive element 50 has a so-called twisted structure in which the orientation of the molecular axis of the liquid crystal compound continuously changes from one interface side to the other interface side in a thickness direction from the viewpoint of increasing the efficiency of diffracted light and obtaining polarization preservation, and the like. The transmissive liquid crystal diffractive element 50 may include a support and/or an alignment film in addition to the optically anisotropic film.

In the example shown in FIG. 5, the transmissive liquid crystal diffractive element 50 includes a region 50a and a region 50b into which the dextrorotatory circularly polarized light I_{R1} and the levorotatory circularly polarized light I_{L1} split by the light splitting element 10 are incident, respectively. In the region 50a, the dextrorotatory circularly polarized light I_{R1} incident from the lower left direction is diffracted to travel in the right direction. In addition, the circularly polarized light transmitted through the transmissive liquid crystal diffractive element 50 (region 50a) is converted in turning direction, and thus is emitted as the levorotatory circularly polarized light I_{L2}. In addition, in the region 50b, the levorotatory circularly polarized light I_{L1} incident from the upper left direction is diffracted to travel in the right direction. In addition, the circularly polarized light transmitted through the transmissive liquid crystal diffractive element 50 (region 50b) is converted in turning direction, and thus is emitted as the dextrorotatory circularly polarized light I_{R2}.

In this case, the region 50a and the region 50b are the same in the rotation direction of the optical axis in the predetermined liquid crystal alignment pattern where the orientation of the optical axis derived from the liquid crystal compound rotates in the one in-plane direction, and are different in the rotation direction of the optical axis in the twisted structure where the orientation of the optical axis of the liquid crystal compound rotates in the thickness direction. As a result, the dextrorotatory circularly polarized light I_{R1} can be diffracted with a higher diffraction efficiency in the region 50a, and the levorotatory circularly polarized light I_{L1} can be diffracted with a higher diffraction efficiency in the region 50b.

The levorotatory circularly polarized light I_{L2} emitted from the transmissive liquid crystal diffractive element 50 is incident into the region 12a of the retardation plate 12 to be converted into the linearly polarized light I_{P1}, and the dextrorotatory circularly polarized light I_{R2} emitted from the transmissive liquid crystal diffractive element 50 is incident into the region 12b of the retardation plate 12 to be converted into the linearly polarized light I_{P2}.

From the above, the beam splitter shown in FIG. 5 splits incident light into two linearly polarized light components to emit the two linearly polarized light components in directions parallel to each other.

FIG. 6 is a diagram conceptually showing another example of the configuration of the beam splitter according to the embodiment of the present invention.

The beam splitter shown in FIG. 6 includes a reflective light splitting element (reflective liquid crystal diffractive element) 60 as the light splitting element, mirrors 61 and 62 as the light collimating member, and the retardation plate 12. In the example shown in FIG. 6, the retardation plate 12 is the same as that of the example shown in FIG. 1 and the like, and thus the description thereof will not be repeated.

In FIG. 6, the light splitting element 60 is the reflective light splitting element, and a reflective liquid crystal diffractive element, a surface relief element, or the like can be used as described above. For example, in a case where the reflective liquid crystal diffractive element is used as the light splitting element 60, the reflective liquid crystal diffractive element includes at least a cholesteric liquid crystal layer that reflects and diffracts dextrorotatory circularly polarized light and a cholesteric liquid crystal layer that reflects and diffracts levorotatory circularly polarized light, and can split incident light into the dextrorotatory circularly polarized light and the levorotatory circularly polarized light by allowing the diffraction direction of the dextrorotatory circularly polarized light and the diffraction direction of the levorotatory circularly polarized light to be different from each other.

In the example shown in FIG. 6, an angle between the dextrorotatory circularly polarized light I_{R1} and the levorotatory circularly polarized light I_{L1} split by the light splitting element 60 is o, and each of the dextrorotatory circularly polarized light I_{R1} and the levorotatory circularly polarized light In is emitted at an angle of φ/2 with respect to the normal direction of the light splitting element 60. In addition, the light splitting element 60 diffracts the dextrorotatory circularly polarized light I_{R1} and the levorotatory circularly polarized light I_{L1} at substantially the same polar angle in orientation directions that are different by 180°. In addition, in the present invention, q is 20° or more.

In the example shown in FIG. 6, in the light splitting element 60, the incidence light I₀ incident from the left to the right side in the drawing in a direction perpendicular to the surface of the light splitting element 60 is split into the dextrorotatory circularly polarized light I_{R1} and the levorotatory circularly polarized light I_{L1}, the dextrorotatory circularly polarized light I_{R1} is reflected and diffracted to travel in the upper left direction in the drawing, and the levorotatory circularly polarized light I_{L1} is reflected and diffracted to travel in the lower left direction in the drawing.

Each of the dextrorotatory circularly polarized light I_{R1} and the levorotatory circularly polarized light I_{L1} is incident into each of the mirror 61 and the mirror 62 that is the light collimating member.

In FIG. 6, the mirror 61 is disposed on the optical path of the dextrorotatory circularly polarized light I_{R1} split by the light splitting element 60, and reflects the incident dextrorotatory circularly polarized light I_{R1} to change the travel direction. In the example shown in FIG. 6, the mirror 61 reflects the dextrorotatory circularly polarized light I_{R1} traveling in the upper left direction in the drawing such that the dextrorotatory circularly polarized light I_{R1} travels in the right direction in the drawing. The circularly polarized light reflected from the mirror 61 is converted in polarization direction, and thus is emitted as the levorotatory circularly polarized light I_{L2}.

In addition, the mirror 62 is disposed on an optical path of the levorotatory circularly polarized light I_{L1} split by the light splitting element 60, and reflects the incident levorotatory circularly polarized light I_{L1} to change the travel direction. In the example shown in FIG. 6, the mirror 62 reflects the levorotatory circularly polarized light I_{L1} traveling in the lower left direction in the drawing such that the levorotatory circularly polarized light I_{L1} travels in the right direction in the drawing. The circularly polarized light reflected from the mirror 62 is emitted as the dextrorotatory circularly polarized light I_{R2}.

The levorotatory circularly polarized light I_{L2} reflected from the mirror 61 is incident into the region 12a of the retardation plate 12 to be converted into the linearly polarized light I_{P1}, and the dextrorotatory circularly polarized light I_{R2} reflected from the mirror 62 is incident into the region 12b of the retardation plate 12 to be converted into the linearly polarized light I_{P2}.

From the above, the beam splitter shown in FIG. 6 splits incident light into two linearly polarized light components to emit the two linearly polarized light components in directions parallel to each other.

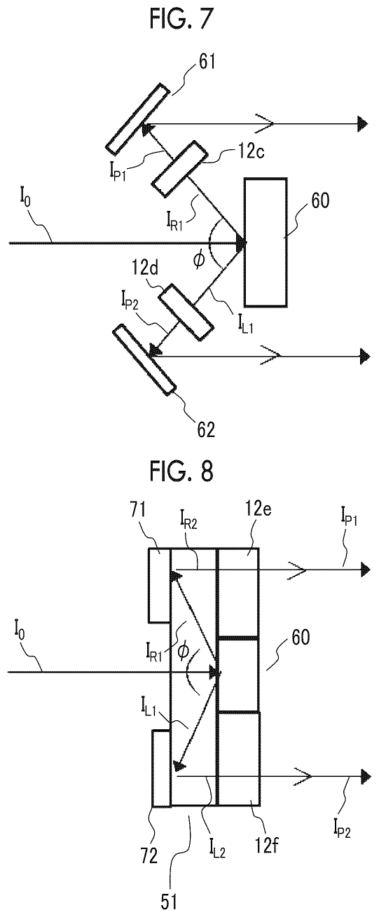

FIG. 7 is a diagram conceptually showing another example of the configuration of the beam splitter according to the embodiment of the present invention.

The beam splitter shown in FIG. 7 includes the reflective light splitting element (reflective liquid crystal diffractive element) 60 as the light splitting element, the mirrors 61 and 62 as the light collimating member, and retardation plates 12c and 12d. The example shown in FIG. 7 has the same configuration as the example shown in FIG. 6, except that the arrangement of the retardation plates is different, and thus different points will be mainly described in the following description.

In the example shown in FIG. 7, the dextrorotatory circularly polarized light I_{R1} split by the light splitting element 60 is reflected and diffracted to travel in the upper left direction in the drawing, and the levorotatory circularly polarized light I_{L1} is reflected and diffracted to travel in the lower left direction in the drawing.

In FIG. 7, the retardation plate 12c is disposed on the optical path of the dextrorotatory circularly polarized light I_{R1} split by the light splitting element 60 and between the light splitting element 60 and the mirror 61, and converts the incident dextrorotatory circularly polarized light I_{R1} into the linearly polarized light I_{P1}. The linearly polarized light I_{P1} converted by the retardation plate 12c is reflected from the mirror 61 to travel in the right direction in the drawing as the linearly polarized light Ip without any change.

In addition, the retardation plate 12d is disposed on the optical path of the levorotatory circularly polarized light I_{L1} split by the light splitting element 60 and between the light splitting element 60 and the mirror 62, and converts the incident levorotatory circularly polarized light I_{L1} into the linearly polarized light I_{P2}. The linearly polarized light I_{P2} converted by the retardation plate 12d is reflected from the mirror 62 to travel in the right direction in the drawing as the linearly polarized light I_{P2} without any change.

In this case, the retardation plate 12c and the retardation plate 12d are λ/4 plates, and slow axis directions of the retardation plate 12c where the dextrorotatory circularly polarized light I_{R1} is incident and the retardation plate 12d where the levorotatory circularly polarized light I_{L1} is incident are different.

From the above, the beam splitter shown in FIG. 7 splits incident light into two linearly polarized light components to emit the two linearly polarized light components in directions parallel to each other.

FIG. 8 is a diagram conceptually showing another example of the configuration of the beam splitter according to the embodiment of the present invention.

The beam splitter shown in FIG. 8 includes the light splitting element 60, the support 51, reflective liquid crystal diffractive elements 71 and 72 as the light collimating member, and retardation plates 12e and 12f. In the example shown in FIG. 8, the light splitting element 60 is the same as that of the example shown in FIG. 6 and the like, and thus the description thereof will not be repeated.

In FIG. 8 the light splitting element 60 is disposed at a substantially central position of a surface of the support 51 opposite to a surface into which the light I₀ is incident, and the retardation plate 12e and the retardation plate 12f are disposed on both end parts of the surface. In addition, the reflective liquid crystal diffractive element 71 and the reflective liquid crystal diffractive element 72 are disposed on both end parts of the support 51 on the side into which the light I₀ is incident, respectively. The retardation plate 12e and the reflective liquid crystal diffractive element 71 are disposed to overlap each other in the in-plane direction, and the retardation plate 12f and the reflective liquid crystal diffractive element 72 are disposed to overlap each other in the in-plane direction.

That is, the support 51 supports the light splitting element 60, the reflective liquid crystal diffractive element 71, the reflective liquid crystal diffractive element 72, the retardation plate 12e, and the retardation plate 12f, and holds a predetermined positional relationship between the respective members. The support 51 is formed of a material such as glass or a resin having a high light-transmitting property with respect to target light.

In the example shown in FIG. 8, the light I₀ is incident from a substantially center of the surface of the support 51 where the reflective liquid crystal diffractive element 71 and the reflective liquid crystal diffractive element 72 are disposed, transmits through the support 51, and is incident into the light splitting element 60 of the surface on the opposite side. The light splitting element 60 splits the incident light I₀ into the dextrorotatory circularly polarized light I_{R1} and the levorotatory circularly polarized light I_{L1}. The dextrorotatory circularly polarized light I_{R1} travels in the support 51 in the upper left direction in the drawing, and is incident into the reflective liquid crystal diffractive element 71. In addition, the levorotatory circularly polarized light I_{L1} travels in the support 51 in the lower left direction in the drawing, and is incident into the reflective liquid crystal diffractive element 72.

The reflective liquid crystal diffractive element 71 and the reflective liquid crystal diffractive element 72 reflect and diffract the incident circularly polarized light. As in the reflective liquid crystal diffractive element as the light splitting element 60, the reflective liquid crystal diffractive element 71 and the reflective liquid crystal diffractive element 72 may include a cholesteric liquid crystal layer, and the cholesteric liquid crystal layer is formed of a composition including a liquid crystal compound and has a predetermined liquid crystal alignment pattern in which an orientation of an optical axis derived from the liquid crystal compound continuously rotates in one in-plane direction. The reflective liquid crystal diffractive element 71 and the reflective liquid crystal diffractive element 72 may include a support and/or an alignment film in addition to the cholesteric liquid crystal layer.

In the example shown in FIG. 8, the reflective liquid crystal diffractive element 71 reflects and diffracts the dextrorotatory circularly polarized light I_{R1} incident from the lower right direction such that the dextrorotatory circularly polarized light I_{R1} travels in the right direction. The reflected and diffracted dextrorotatory circularly polarized light I_{R2} is incident into the retardation plate 12e to travel in the support 51. That is, the reflective liquid crystal diffractive element 71 includes the cholesteric liquid crystal layer that reflects the dextrorotatory circularly polarized light.

In addition, the reflective liquid crystal diffractive element 72 reflects and diffracts the levorotatory circularly polarized light I_{L1} incident from the upper right direction such that the levorotatory circularly polarized light I_{L1} travels in the right direction. The reflected and diffracted levorotatory circularly polarized light I_{L2} is incident into the retardation plate 12f to travel in the support 51. That is, the reflective liquid crystal diffractive element 72 includes the cholesteric liquid crystal layer that reflects the levorotatory circularly polarized light.

In the case of reflection from the cholesteric liquid crystal layer, the turning direction of the circularly polarized light does not change.

The dextrorotatory circularly polarized light I_{R2} reflected from the reflective liquid crystal diffractive element 71 is incident into the retardation plate 12e to be converted into the linearly polarized light I_{P1}. In addition, the levorotatory circularly polarized light I_{L2} reflected from the reflective liquid crystal diffractive element 72 is incident into the retardation plate 12f to be converted into the linearly polarized light I_{P2}.

From the above, the beam splitter shown in FIG. 8 splits incident light into two linearly polarized light components to emit the two linearly polarized light components in directions parallel to each other.

The beam splitter according to the embodiment of the present invention can be used as an optical wavelength selective switch system.

The optical wavelength selective switch system has a function of splitting wavelength components in an optical signal transmitted through an optical fiber in wavelength multiplexing communication from each other and distributing each of the split wavelength components to a predetermined route. The optical wavelength selective switch system includes: a wavelength dispersive element that spatially splits and emits incident light for each of wavelengths; and a deflection unit that distributes the light incident from the wavelength dispersive element to a predetermined route by deflecting the light such that a reflection angle or a transmission angle of the light is variable for each of wavelengths.

As the wavelength dispersive element, for example, a prism, a surface relief diffractive element (surface relief grating: SRG), or an arrayed waveguide diffractive element (arrayed waveguide grating: AWG) is used.

As the deflection unit, a liquid crystal optical element represented by a micromirror device or a liquid crystal on silicon (LCOS) can be used.

The beam splitter according to the embodiment of the present invention can be used as an element that is disposed on an input side of the optical wavelength selective switch system, that is, upstream of the wavelength dispersive element and splits light input to the optical wavelength selective switch system such that the split light is incident into the wavelength dispersive element. The diffractive element (in particular, the surface relief diffractive element) as the wavelength dispersive element in the optical wavelength selective switch system has wavelength dependence on the diffraction efficiency. Therefore, by allowing P polarized light to be incident, the diffraction efficiency can be stabilized. A method of allowing a polarizing plate to convert incidence light into P polarized light can also be adopted, but the amount of light is reduced to about half. On the other hand, the beam splitter can suppress a decrease in the amount of light caused by converting incidence light into P polarized light.

The beam splitter according to the embodiment of the present invention can be used as an element that is disposed on an output side of the optical wavelength selective switch system, that is, downstream of the deflection unit and further splits at least one of the light components split by the optical wavelength selective switch system for each of the wavelengths.

Hereinabove, the beam splitter and the optical wavelength selective switch system according to the embodiment of the present invention have been described in detail. However, the present invention is not limited to the above-described examples, and various improvements and modifications can be made within a range not departing from the scope of the present invention.

### EXAMPLES

Hereinafter, the characteristics of the present invention will be described in detail using examples. Materials, chemicals, used amounts, material amounts, ratios, treatment details, treatment procedures, and the like shown in the following examples can be appropriately changed within a range not departing from the scope of the present invention. Accordingly, the scope of the present invention is not limited to the following specific examples. (Example of Embodiment of Beam Splitter)

With reference to a compound described in WO2021/256413A, the addition amounts of a right-twisted chiral agent and a left-twisted chiral agent were adjusted such that an in-plane pitch was 2.4 [μm] and each of twisted angles was 110°, a laminate of optically anisotropic films having the right-twisted structure and the left-twisted structure was formed, and a transmissive liquid crystal diffractive element having a splitting angle of 40° at a wavelength of 1550 [nm] and a film thickness of 1.12 [μm] was prepared. That is, the optically anisotropic film is the light splitting element. In addition, the thickness of the photo-alignment film was 80 [nm], and glass having a thickness of 1.0 [mm] was used as the support. Therefore, an element having a total thickness of 1.0013 [mm] was prepared.

In addition, an optically anisotropic film formed using the same method as that of the above-described optically anisotropic film was bonded to half of a region of the support opposite to the optically anisotropic film as the light splitting element. In addition, an optically anisotropic film formed using the same method as that of the above-described optically anisotropic film was inverted and bonded to the remaining half of the region of the support. The two regions are the light collimating members. As a result, the beam splitter was formed. The total thickness of the beam splitter was 1.0026 mm, and the distance between the split light components was 0.73 mm. As described above, a reduction in the thickness of the beam splitter can be realized.

As a device for measuring the splitting angle of transmitted light, a photodiode power sensor (S122C, manufactured by Thorlabs, Inc.) and a rotation stage (manufactured by Thorlabs, Inc., RBB450A/M) were used. The photodiode power sensor was disposed such that one transmitted light was vertically incident thereinto, and an angle between the optically anisotropic film and the photodiode power sensor was measured based on gradations of the rotation stage. In addition, an angle was measured for the other transmitted light, and the sum of the angles was obtained as the splitting angle.

### EXPLANATION OF REFERENCES

10: light splitting element (transmissive liquid crystal diffractive element)
51: support (glass)
11: light collimating member
12, 12c to 12f: retardation plate
12a, 12b: region
21, 22, 61, 62: mirror
30: lens
40: prism
50: transmissive liquid crystal diffractive element
50a, 50b: region
60: light splitting element (reflective liquid crystal diffractive element)
71, 72: reflective liquid crystal diffractive element
I₀: incidence light
I_{R1}: split dextrorotatory circularly polarized light
I_{L1}: split levorotatory circularly polarized light
I_{R2}: collimated dextrorotatory circularly polarized light
I_{L2}: collimated levorotatory circularly polarized light
I_{P1}, I_{P2}: P polarized light (linearly polarized light)
φ: splitting angle

What is claimed is:

1. A beam splitter comprising:
a light splitting element that splits incident light in two directions; and
a light collimating member for collimating the split light components,
wherein the light splitting element is a diffractive element, and
a splitting angle of the light splitting element is 20° or more.

2. The beam splitter according to claim 1,
wherein the light splitting element is a liquid crystal diffractive element.

3. The beam splitter according to claim 1,
wherein the liquid crystal diffractive element has a twisted structure of liquid crystals.

4. The beam splitter according to claim 1,
wherein the liquid crystal diffractive element has cholesteric alignment.

5. The beam splitter according to claim 1, further comprising:
a retardation plate that is provided between the light splitting element and the light collimating member or on an emission side of the light collimating member.

6. An optical wavelength selective switch system comprising:
the beam splitter according to claim 1.

7. The beam splitter according to claim 2,
wherein the liquid crystal diffractive element has a twisted structure of liquid crystals.

8. The beam splitter according to claim 2,
wherein the liquid crystal diffractive element has cholesteric alignment.

9. The beam splitter according to claim 2, further comprising:
a retardation plate that is provided between the light splitting element and the light collimating member or on an emission side of the light collimating member.

10. An optical wavelength selective switch system comprising:
the beam splitter according to claim 2.

11. The beam splitter according to claim 3, further comprising:
a retardation plate that is provided between the light splitting element and the light collimating member or on an emission side of the light collimating member.

12. An optical wavelength selective switch system comprising:
the beam splitter according to claim 3.

13. The beam splitter according to claim 4, further comprising:
a retardation plate that is provided between the light splitting element and the light collimating member or on an emission side of the light collimating member.

14. An optical wavelength selective switch system comprising:
the beam splitter according to claim 4.

15. An optical wavelength selective switch system comprising:
the beam splitter according to claim 5.
